(19) United States
(12) Patent Application Publication
(10) Pub. No.: US 2006/0225049 A1
(43) Pub. Date: Oct. 5, 2006

(54) Trace based signal scheduling and compensation code generation

(76) Inventors: Zhiyuan Lv, Shanghai (CN); Jinquan Dai, Shanghai (CN); Long Li, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/084,816

(22) Filed: Mar. 17, 2005

(51) Int. Cl. G06F 9/44

(52) U.S. Cl. 717/128

(57) ABSTRACT

A method and apparatus for selecting a trace in a program and scheduling a consume signal instruction in the trace according to a only a dependency in the trace.

### TECHNICAL FIELD

Embodiments of this invention relate to the field of processors and, in particular, to the scheduling of instructions in a processor.

### BACKGROUND

Advances in microprocessor technology helped pave the way for the development of network processors (NPs), which are designed specifically to meet the requirements of next generation network equipments. In order to address the unique challenges of network processing at high speeds, i.e., where inter-arrival times between packets may be less than single memory access latency, modern network processors generally have asynchronous (non-blocking) memory access operations, so that other computation work can be overlapped with the latency of the memory accesses.

For instance, in the Intel® IXA NP family of network processors (IXP), every memory access instruction is non-blocking and is associated with an event signal; once the memory access is completed, the associated signal is asserted by the hardware. That is, when a memory access instruction is issued, other instructions following it can continue to run while the memory access is in flight, until a wait instruction (for the associated signal) blocks the execution. When the associated signal is asserted, the wait instruction clears the signal and returns to execution. Consequently, all the instructions between the memory access instruction and the wait instruction can be overlapped with the latency of the memory access, as illustrated in FIGS. 1a and 1b. More specifically, FIG. 1a illustrates an asynchronous memory access operation, and FIG. 1b illustrates event signal and the overlap of latency.

Instructions that depend on the completion of the particular memory access, however, should not be executed until the associated signal is asserted, and cannot be overlapped with the latency of the memory access. For instance, an instruction that uses the result of a load instruction has to wait for the completion of the load, as illustrated in FIG. 2a. Similarly, an instruction that overwrites the source of a store instruction has to wait for the completion of the store, as illustrated in FIG. 2b. This can be guaranteed by inserting an appropriate wait instruction between the memory access and the dependent instruction.

Therefore, in order to increase the overlap of the latency, the memory access instructions and their dependent instructions should be scheduled as apart as possible. Some conventional scheduling technologies to accomplish this include list scheduling, super-block scheduling and trace scheduling.

### BRIEF DESCRIPTION OF THE DRAWINGS

The present invention is illustrated by way of example and not intended to be limited by the figures of the accompanying drawings.

FIG. 1a illustrates an asynchronous memory access operation.

FIG. 1b illustrates an event signal and overlap of latency.

FIG. 2a illustrates a load instruction and its dependent instruction.

FIG. 2b illustrates a store instruction and its dependent instruction.

FIG. 3a illustrates one embodiment of an example program.

FIG. 3b illustrates one embodiment of a transformation of the program illustrated in FIG. 3a.

FIG. 3c illustrates one embodiment of properties for program correctness.

FIG. 4 illustrates one embodiment of a method to schedule a consume s instruction globally, based on the trace information.

FIG. 5a illustrates one embodiment of an example of a broken property when a scheduler sinks a consume s across a depend s.

FIG. 5b illustrates one embodiment of an example of a broken property when the scheduler sinks a consume s across a produce s.

FIG. 6 illustrates one embodiment of a program having scheduled consume signal instructions in a trace.

FIG. 7 is a flow chart illustrating one embodiment of adjusting consume s instructions in an off-trace code of a program.

FIG. 8 illustrates one embodiment of a transformed program of FIG. 6 having adjusted consume s instructions in off trace codes.

FIG. 9 is a flow chart illustrating one embodiment of a method of generating a compensation code in an off-trace code.

FIG. 10 illustrates one embodiment of a transformed program of FIG. 6 having a generated compensation code in an off trace code.

FIG. 11 illustrates one embodiment of an operation methodology of programming instructions in a processing device using a compiler.

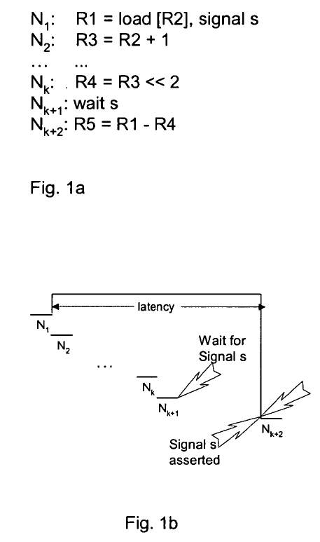

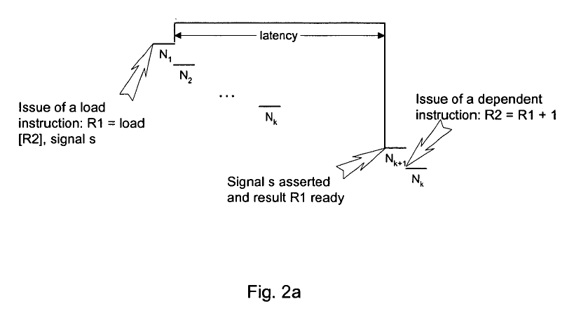

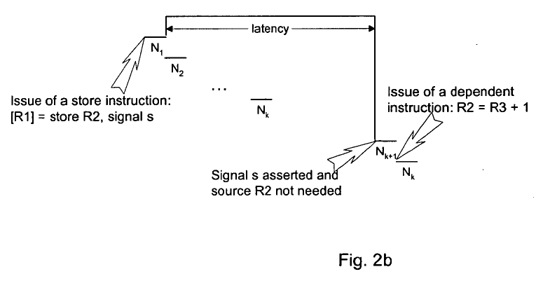

### DETAILED DESCRIPTION

In the following description, numerous specific details are set forth such as examples of specific systems, techniques, components, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention.

Embodiments of the present invention include various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

Embodiments of the present invention may be provided as a computer program product, or software, that may include a machine-readable medium having stored thereon instructions, which may be used to program a computer system (or other electronic devices) to perform a process according to embodiments of the present invention. A machine readable medium includes any mechanism for storing or transmitting information in a form (e.g., software, processing application) readable by a machine (e.g., a computer). The machine-readable medium may includes, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other type of medium suitable for storing electronic instructions.

In one embodiment, instructions in a computer program may be categorized into four classes for signal scheduling as follows: produce signal (s) instruction, consume s instruction, depend s instruction, and ignore instruction. The produce s instruction may be composed of an instruction that generates the signal s, such as a memory access instruction with signal s. Another instruction, send_signal, may be used to generate the signal as well. The consume s instruction may be composed of a wait instruction that consumes the signal s; that is, it waits for the signal s and clears the signal once it is asserted. The depend s instruction may be composed of an instruction that depends on the completion of memory accesses which also depend on the associated signals. The ignore instruction may be composed of an instruction that does not use or depend on signals and is ignored in the signal scheduling.

A method and apparatus for globally scheduling program instructions based on trace information is described. In one embodiment, a compiler selects a trace (a sequence of basic blocks) in a program, for example, either based on heuristics or actual profiling information, and schedules consume s instructions in the trace as if in a basic block. In addition, compensation codes may be used in the off-trace codes, so as to ensure the correctness of the program.

Although the access operations are discussed herein at times with particular reference to a memory access, such is only for ease of discussion purposes. It should be noted that in alternative embodiments, other types of access operations may be performed, for example, I/O access operations such as I/O reads and writes.

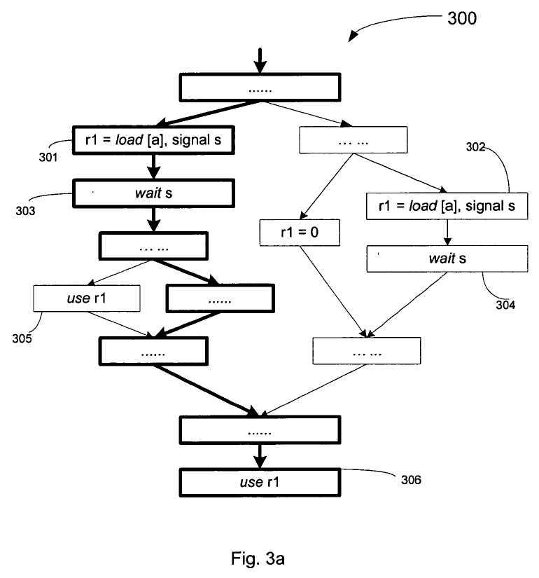

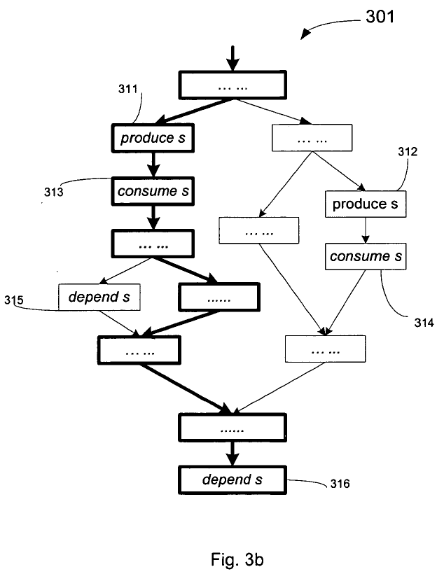

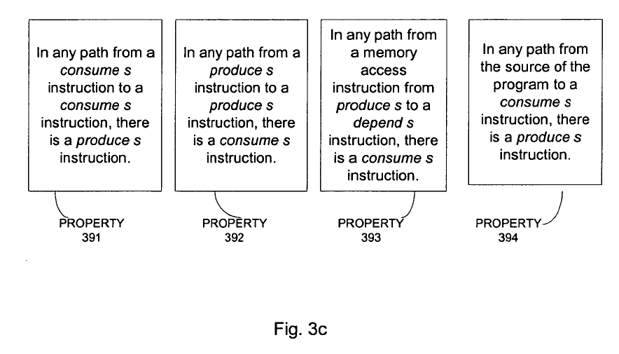

FIG. 3a illustrates an example program, where the selected trace is shown in bold lines. For scheduling, the instructions in the example program 300 of FIG. 3a may be characterized as follows. The two load instructions 301 and 302 of FIG. 3a may be characterized as produce s instructions 311 and 312, respectively. The two wait instructions 303 and 304 may be characterized as consume s instructions 313 and 314, respectively. The two “use r1 ” instructions 305 and 306 may be characterized as depend s instructions 315 and 316, respectively. Accordingly, the program 300 illustrated in FIG. 3a may be transformed into the program 301 as illustrated in FIG. 3b for the sake of signal scheduling. It should be noted that ignore instructions are not shown in FIG. 3b.

FIG. 3c illustrates one embodiment of properties for program correctness. In one embodiment, a program may be guaranteed to be correct (in terms of the hardware properties of the event signal) if and only if the following properties exist. In any path from a consume s instruction to a consume s instruction, there is a produce s instruction, property 391. Once a signal s is consumed, it is automatically cleared by the hardware. Therefore, the signal has to be produced before it can be consumed again.

In any path from a produce s instruction to a produce s instruction, there is a consume s instruction, property 392. Once a signal is asserted by the hardware, it remains so until it is cleared. Therefore, to ensure the unambiguity, the signal has to be consumed before it can be produced again.

In any path from a memory access instruction from a produce s to a depend s instruction, there is a consume s instruction, property 393. This is to guarantee that the dependent instructions are issued after the completion of the memory accesses.

In any path from the source of the program to a consume s instruction there is a produce s instruction, property 394. A consume s instruction blocks the execution until the signal s is asserted by the hardware. Therefore, the signal has to be produced before it can be ever consumed. In addition, if an artificial consume s instruction is inserted at the beginning of a program, this is simply a special form of property 391.

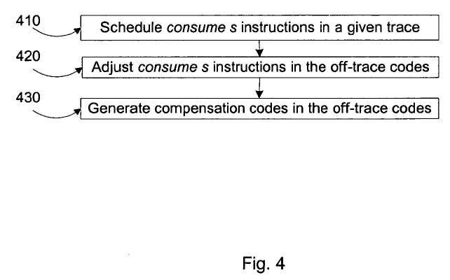

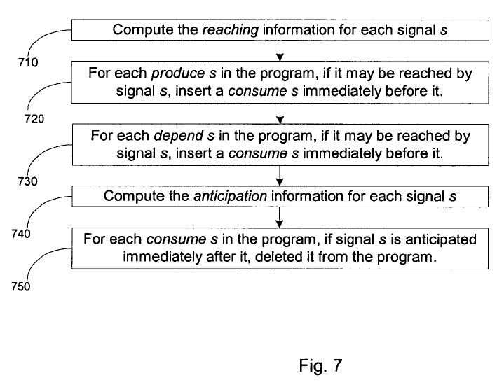

FIG. 4 illustrates one embodiment of a method to schedule a consume s instruction globally, based on the trace information. Given a trace in the program, the consume s instructions in the trace are first scheduled as if in a basic block, i.e., according to the dependence in that trace only, step 410. Then, in step 420, the consume s instructions in other paths are adjusted based on the reaching information and the anticipation information of the signals in the program, as discussed below in one embodiment in relation to FIG. 7. Next, in step 430, instructions that generate signals are introduced as compensation codes in the off-trace code so as to ensure the correctness of a program.

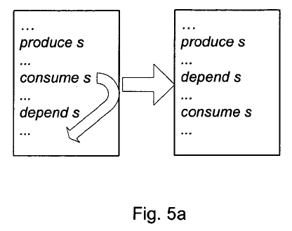

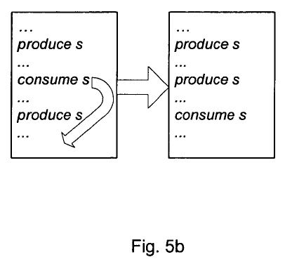

In the step 410, consume s instructions (e.g., such as a wait instruction), are scheduled as late as possible in the trace, so long as the above four properties 391-394 in the given trace are satisfied. It is apparent that a consume s instruction cannot sink across a depend s instruction or a produce s instruction in the trace during the scheduling, as illustrated in FIG. 5a and FIG. 5b. Otherwise, the above properties will be broken, as illustrated in FIGS. 5a and 5b. In particular, FIG. 5a illustrates the broken property when the scheduler sinks a consume s across a depend s. FIG. 5b illustrates the broken property when the scheduler sinks a consume s across a produce s.

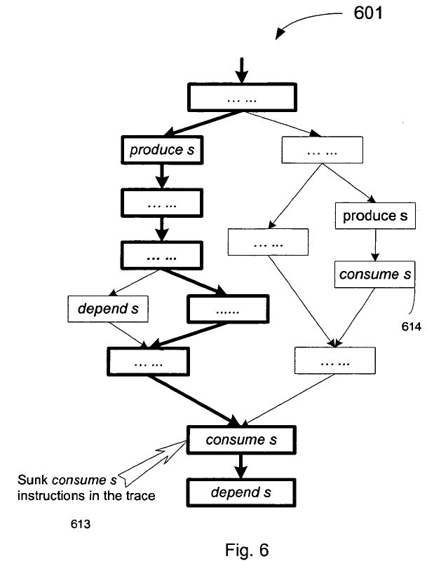

Therefore, the scheduler sinks the consume s instruction along the trace, until it reaches a depend s instruction or a produce s instruction. If there are not such instructions in the trace, the consume s instruction is moved to the end of the trace. For instance, the example program 301 of FIG. 3b is transformed into the program 601 as shown in FIG. 6 after the first step 410, where consume s instruction 313 of FIG. 3b has been moved to immediately before the depend s instruction in the position as illustrated by sunk consume s instruction 613.

In this embodiment, it is guaranteed that the above four properties 391-394 are satisfied in the trace after the first step 410 of FIG. 4. However, these properties may have been broken in the off-trace codes, as illustrated by FIG. 5. In the second step 420 of FIG. 4, extra consume s instructions are introduced and redundant consume s instructions are deleted in the off-trace codes. It is guaranteed that, after this step 420, properties 392 and 393 are satisfied and redundant consume s instructions are eliminated in the program.

FIG. 7 is a flow chart illustrating one embodiment of adjusting consume s instructions in off-trace codes. In this embodiment, in step 710, the reaching information of each signal s is computed using a forward disjunctive dataflow analysis. For each instruction n, the dataflow equations are as follows;
GEN[n]={s|instruction n is a produce s instruction}
KILL[n]={s|instruction n is a consume s or depend s instruction}

After the reaching information for each signal s is computed, steps 720 and 730 introduce a consume s instruction immediately before any produce s or depend s instruction which signal s may reach, so as to satisfy properties 392 and 393. As those two properties are already satisfied in the given trace, extra consume s instructions are only needed in the off-trace codes.

In step 740, the anticipation information for each signal s is computed using a backward conjunctive dataflow analysis. For each instruction n, the dataflow equations are as follows:
GEN[n]={s|instruction n is a consume s instruction}
KILL[n]={s|instruction n is a produce s or depend s instruction}

After the anticipation information for each signal s is computed, step 750 deletes any consume s instructions immediately after which signal s is anticipated. Hence, all the redundant consume s instructions are eliminated from the program.

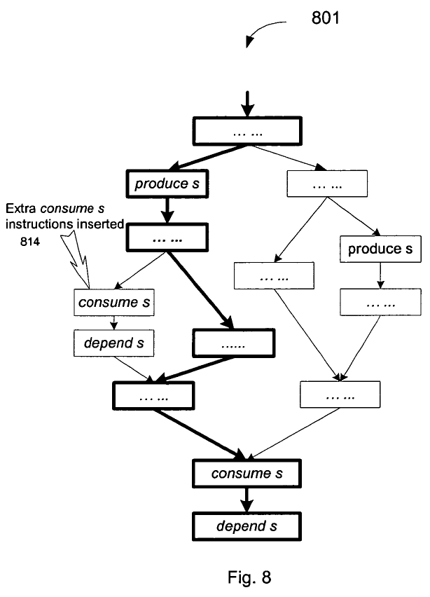

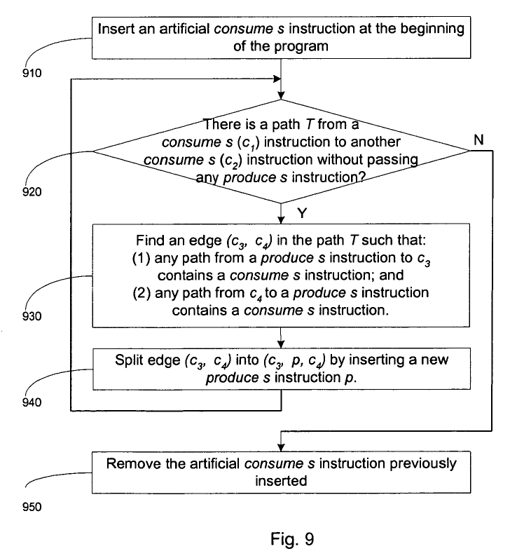

For instance, after step 750, the example program 601 in FIG. 6 is transformed into the program 801 as shown in FIG. 8. In particular, the redundant consume s instruction 614 in program 601 of FIG. 6 is deleted and an extra consume s instruction 814 is inserted. However, property 391 or property 394 may still be broken in the program, which may be addressed by step 420. In step 420, additional produce s instructions are generated as compensation codes in the off-trace codes, so that the properties 391 and 394 are satisfied in the program, for example, as illustrated in FIG. 9.

FIG. 9 is a flow chart illustrating one embodiment of a method of generating compensation codes in off-trace codes. In this embodiment, in step 910, the method inserts an artificial consume s instruction at the beginning of the program, so that the first property and the forth property can be handled uniformly. In step 920, the method tries to find a path T from one consume s instruction (c₁) to another consume s instruction (c₂) without passing any produce s instructions in the program. If such a path is found, property 391 is broken if c₁ is not the artificial consume s instruction, or property 394 is broken if c₁ is the artificial consume s instruction.

Once such a path T is found, in step 930, the method tries to find an edge (c₃, c₄) in the path T such that (1) any path from a produce s instruction to an edge tail node (c₃) contains a consume s instruction, and (2) any path from the edge header node (c₄) to a produce s instruction contains a consume s instruction.

It can be shown that such an edge (c₃, c₄) exits in the program as follows, as long as properties 391 and 392 are satisfied in the program:

Assume for path T=(c₁, n₁, n₂, . . . , nₖ, c₂), there is no such an edge.
For edge (c₁, n₁), since c₁ itself is a consume s instruction, any path from a produce s instruction to c₁ contains a consume s instruction (i.e., c₁). If any path from n₁ to a produce s instruction contains a consume s instruction, (c₁, n₁) is the edge step 920 tries to find, which contradicts with the assumption. Therefore, there is a path T₁ from n₁ to a produce s instruction (p₁) that does not contain a consume s instruction, and n₁ is not a consume s instruction.
Then for edge (n₁, n₂), if there is a path T₂ from a produce s instruction (p₂) to n₁ that does not contain any consume s instruction, path (T₂, T₁)=(p₂, . . . , n₁, . . . , p₁) is a path from a produce s instruction (p₂) to another produce s instruction (p₁) without passing a consume s instruction, which contradicts with the property 392. Therefore, there is a path from n₂ to a produce s instruction that does not contain a consume s instruction, and n₂ is not a consume s instruction.
By the above deduction, it follows that there is a path from c₂ to a produce s instruction that does not contain a consume s instruction, and c₂ is not a consume s instruction, which, however, contradicts with the condition that c₂ itself is a consume s instruction.

Properties 392 and 393 are satisfied before step 930. In this step 930, additional produce s instructions are only inserted by splitting such an edge in step 940. Hence, it is guaranteed that the properties 392 and 393 are always satisfied in step 930, and step 930 can always find such an edge.

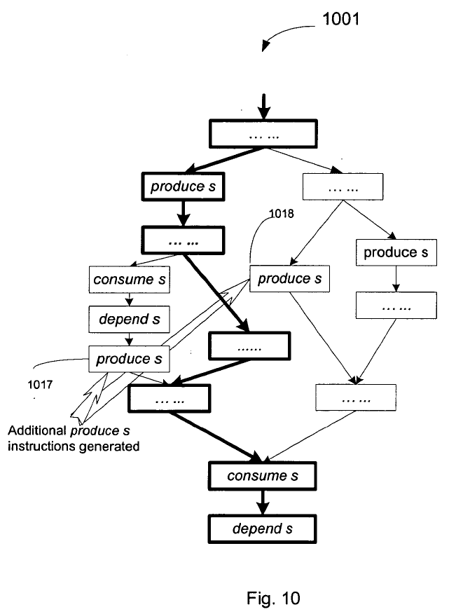

The method in step 930 keeps searching for a path from one consume s instruction (c₁) to another consume s instruction (c₂) without passing any produce s instructions in the program in step 920. If no such paths are found, it is guaranteed that the properties 391 and 394 are satisfied. No more compensation codes are required, and step 950 simply removes the artificial consume s instruction previously inserted in step 910. For instance, the example program 801 in FIG. 8 is transformed into the program 1001 illustrated in FIG. 10 where additional produce s instructions 1017 and 1018 have been generated.

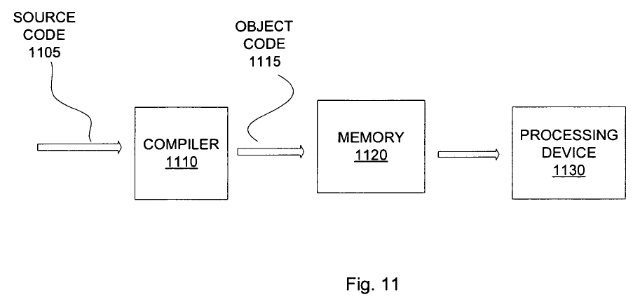

FIG. 11 illustrates one embodiment of an operation methodology of programming instructions in a processing device using a compiler. Compiler 1110 may be resident on a computer system in the form of a machine-readable medium having stored thereon instructions, which when executed by a processing device of the computer system, translates code from one language to another. In particular, compiler 1110 receives source code 1105 and generates object code 1115 according to the scheduling operations discussed above in regards to FIGS. 3-10. The source code 1105 may be written in any programming language. In one particular embodiment, the compiler 1110 is a C-based language compiler. Alternatively, other programming language compliers may be used. Compiler 1110 translates the source code 1105 into object code 1110 (e.g., assembler language). One step in the compiler's generation of object code 1115 is instruction scheduling. During instruction scheduling, individual instructions to be generated in the object code 1115 are rescheduled to enable faster execution and/or more efficient use of resources in processing device 1130.

Complier 1110 may be coupled to a memory 1120 used to store the object code 1115 generated by the compiler. In one embodiment, memory 1120 may be a FLASH memory. Alternatively, other types of memories may be used, for example, a random access memory (RAM) or read only memory (ROM). The object code 1115 that is stored on memory 1120 may be loaded into processing device 1130. Processing device 1130 may execute instructions based on the object code 1115 load thereon from memory 1120.

Processing device 1130 may include on or more processors. In one embodiment, for example, processing device 1130 may be a network processor having multiple processors including a core unit and multiple microengines. In one particular embodiment, processing device 1130 may be one of the network processors in the Intel® IXA NP family of network processors. Alternatively, processing device 1130 may be another type of network processor.

In another embodiment, processing device 1130 may represent another type of processing device such as a general purpose processor (e.g., central processing unit (CPU), microprocessor) or special purpose processor (e.g., digital signal processors (DSP)), an application specific integrated circuit (ASIC), or other type of processing devices.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method, comprising:
selecting a trace in a program; and
scheduling a consume signal instruction in the trace according to a only a dependency in the trace, wherein the consume signal instruction is an instruction that waits for a signal and clears the signal once the signal is asserted.

2. The method of claim 1, wherein the consume signal instruction is scheduled as late as possible in the trace.

3. The method of claim 2, wherein scheduling comprises:
moving the consume signal instruction along the trace until it reaches at least one of a depend signal instruction or a produce signal instruction, wherein the depend signal instruction depends on a completion of an access and an associated signal, and wherein the produce signal instruction generates the signal; and
if there no depend signal instruction or produce signal instruction is reached, moving the consuming signal instruction to an end of the trace.

4. The method of claim 3, further comprising adjusting the consume signal instruction in an off-trace code.

5. The method of claim 4, wherein adjusting comprises:
computing a reaching information for the signal;
for each produce signal instruction and depend signal instruction in the program, if reachable by the signal, inserting an immediately preceding consume signal instruction;
computing an anticipation information for the signal; and
deleting each consume signal instruction in the program, if the signal is anticipated immediately thereafter.

6. The method of claim 5, wherein computing the reaching information comprises using a forward disjunctive analysis flow.

7. The method of claim 5, wherein computing the anticipation information comprises using a backward conjunctive dataflow analysis.

8. The method of claim 5, further comprising generating a compensation code in an off-trace code.

9. The method of claim 8, wherein generating the compensation code in the off-trace code comprises:
inserting an artificial consume signal instruction at a beginning of the program;
determining if there is a path from a first consume signal instruction to a second consume signal instruction without passing any produce signal instruction.

10. The method of claim 9, wherein if it is determined that there is the path from a first consume signal instruction to a second consume signal instruction without passing any produce signal instruction, the method further comprises finding an edge in the path so that any path from a produce signal instruction to an edge tail node contains another consume signal instruction and any path from an edge header node to a produce signal instruction contains another consume signal instruction.

11. The method of claim 9, wherein if it is determined that there is not the path from a first consume signal instruction to a second consume signal instruction without passing any produce signal instruction, the method further comprises removing the artificial consume signal instruction previously inserted.

12. An article of manufacture, comprising
a machine-accessible medium including data that, when accessed by a machine, cause the machine to perform operations comprising:
selecting a trace in a program; and
scheduling a consume signal instruction in the trace according to a only a dependency in the trace, wherein the consume signal instruction is an instruction that waits for a signal and clears the signal once the signal is asserted.

13. The article of manufacture of claim 12, wherein scheduling comprises:
moving the consume signal instruction along the trace until it reaches at least one of a depend signal instruction or a produce signal instruction, wherein the depend signal instruction depends on a completion of an access and an associated signal, and wherein the produce signal instruction generates the signal; and
if there no depend signal instruction or produce signal instruction is reached, moving the consuming signal instruction to an end of the trace.

14. The article of manufacture of claim 13, wherein the data, when accessed by the machine, cause the machine to perform operations further comprising adjusting the consume signal instruction in an off-trace code, wherein the adjusting comprises:
computing a reaching information for the signal;
for each produce signal instruction and depend signal instruction in the program, if reachable by the signal, inserting an immediately preceding consume signal instruction;
computing an anticipation information for the signal; and
deleting each consume signal instruction in the program, if the signal is anticipated immediately thereafter.

15. The article of manufacture of claim 14, wherein computing the reaching information comprises using a forward disjunctive analysis flow and wherein computing the anticipation information comprises using a backward conjunctive dataflow analysis.

16. The article of manufacture of claim 15, wherein the data, when accessed by the machine, cause the machine to perform operations further comprising generating a compensation code in an off-trace code, the generating comprising:
inserting an artificial consume signal instruction at a beginning of the program;
determining if there is a path from a first consume signal instruction to a second consume signal instruction without passing any produce signal instruction.

17. The article of manufacture of claim 16,
wherein if it is determined that there is the path from a first consume signal instruction to a second consume signal instruction without passing any produce signal instruction, the machine is further caused perform finding an edge in the path so that any path from a produce signal instruction to an edge tail node contains another consume signal instruction and any path from an edge header node to a produce signal instruction contains another consume signal instruction; and
wherein if it is determined that there is not the path from a first consume signal instruction to a second consume signal instruction without passing any produce signal instruction, the machine is further caused perform removing the artificial consume signal instruction previously inserted.

18. An apparatus, comprising:
a memory including machine executable instructions comprising a first consume signal instruction scheduled in a trace of program according to a only a dependency in the trace, wherein the first consume signal instruction is an instruction that waits for a signal and clears the signal once the signal is asserted; and
a network processor coupled to the memory to receive and execute the instructions.

19. The apparatus of claim 18, wherein the machine executable instructions further comprise off-trace codes of the program having an adjusted consume signal instruction.

20. The apparatus of claim 19, wherein the off-trace codes of the program further comprises compensation codes.
